(19) United States
(12) Patent Application Publication
(10) Pub. No.: US 2026/0054243 A1
(43) Pub. Date: Feb. 26, 2026

(54) FLOW CELL PATTERNING METHODS WITH FUNCTIONALIZED NANOPARTICLES

(71) Applicant: ILLUMINA, INC., San Diego, CA (US)

(72) Inventors: Tyler Dill, San Diego, CA (US); Robert Yang, San Diego, CA (US)

(21) Appl. No.: 19/305,072

(22) Filed: Aug. 20, 2025

Related U.S. Application Data
(60) Provisional application No. 63/685,973, filed on Aug. 22, 2024.

(51) Int. Cl. B01J 19/00; G01N 15/1434

(52) U.S. Cl. CPC B01J 19/0046; G01N 15/1436; B01J 2219/00621; B01J 2219/00639; B01J 2219/00722

(57) ABSTRACT

In a method of preparing a flow cell, a slot die coater is used to introduce a nanoparticle suspension at a continuous flow rate to a substrate surface including depressions separated by interstitial regions, which generates a layer of the nanoparticle suspension at a stable concentration across the substrate surface. During the introduction of the nanoparticle suspension, at least some functionalized nanoparticles within the layer respectively enter at least some of the depressions. An excess amount of the layer is removed from the interstitial regions.

### CROSS-REFERENCE TO RELATED APPLICATIONS

This application claims the benefit of U.S. Provisional Application Ser. No. 63/685,973, filed Aug. 22, 2024, the content of which is incorporated by reference herein in its entirety.

### REFERENCE TO SEQUENCE LISTING

The instant application contains a Sequence Listing which has been submitted electronically in XML file format and is hereby incorporated by reference in its entirety. Said XML copy, created on Aug. 15, 2025 is named ILI282B_IP-2788-US_Sequence_Listing.xml and is 14,982 bytes in size.

### BACKGROUND

Various protocols in biological or chemical research involve performing a large number of controlled reactions on local support surfaces or within predefined reaction chambers, or reactive areas. The reactions may then be observed or detected, and subsequent analysis may help identify or reveal properties of chemicals involved in the controlled reactions. In some examples, the reactions generate fluorescence, and thus an optical system that is configured for fluorescence detection may be used to analyze the controlled reactions.

### SUMMARY

Methods of patterning surfaces of flow cell substrates with functionalized nanoparticles are disclosed herein. The functionalized nanoparticles described herein are suitable for seeding and clustering biological library templates. During flow cell fabrication and/or preparation, the functionalized nanoparticles become introduced into concave features (e.g., depressions, elongated trenches, conical pits, etc.) that are defined in a surface of a flow cell substrate. The functionalized nanoparticles allow pre-clustered nanoparticles, including amplicons of the library templates, to be formed on the nanoparticles prior to the introduction of the functionalized nanoparticles into the depressions (and thus the nanoparticles may be used for off flow cell (i.e., off-board) preparation). As an alternative, non-pre-clustered functionalized nanoparticles can be used to generate amplicons of library templates after the nanoparticles have been introduced into the concave features (and thus the nanoparticles may be used for on flow cell (i.e., on-board) library preparation). As an additional alternative, non-pre-clustered functionalized nanoparticles can be used to provide a spatial genomic map regarding the location of particular oligonucleotide primers on a surface of a flow cell substrate.

The methods disclosed herein involve using a high precision fluid dispensing device, such as a slot-die coater, to introduce a plurality of the functionalized nanoparticles into the concave features defined in the flow cell substrate surface. The functionalized nanoparticles may be included in a suspension that is maintained at a constant flow rate during the introduction of the nanoparticle-inclusive suspension to the substrate surface. Further, the functionalized nanoparticles may be maintained at a stable concentration (relative to the total volume of the suspension) throughout the introduction of the suspension to the substrate surface. In specific examples, the methods disclosed herein facilitate the loading of individual nanoparticles into respective depressions, and in some instances, the loading of the nanoparticles into the depressions in a predetermined configuration (e.g., the right side of the depressions, the left side of the depressions, etc.).

Overall, the methods disclosed herein can be used to prepare flow cell substrates with a high degree of precision and accuracy.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a schematic illustration of an example of a non-pre-clustered functionalized nanoparticle;

FIG. 1B is a schematic illustration of an example of a pre-clustered functionalized nanoparticle;

FIG. 2A is a top view of an example of a flow cell;

FIG. 2B is an enlarged, and partially cutaway view of an example of a flow cell substrate having depressions defined therein, where a functionalized nanoparticle has been loaded into at least some of the individual depressions;

FIG. 3A through FIG. 3D are schematic views that together illustrate one example of a method disclosed herein, where FIG. 3A depicts the introduction of a nanoparticle suspension including a plurality of functionalized nanoparticles to a substrate surface that is patterned with depressions, FIG. 3B depicts the formation of a layer of the nanoparticle suspension over an entirety of the substrate surface, FIG. 3C depicts the movement of individual functionalized nanoparticles (within the layer of the nanoparticle suspension) into respective depressions, and FIG. 3D depicts removing an excess amount of the layer of the nanoparticle suspension from the substrate surface;

FIG. 4A through FIG. 4D are schematic views that together illustrate another example of the method disclosed herein, where FIG. 4A depicts the introduction of a nanoparticle suspension including a plurality of functionalized nanoparticles to a substrate surface that is patterned with depressions, FIG. 4B depicts the formation of a layer of the nanoparticle suspension over an entirety of the substrate surface, FIG. 4C depicts the movement of individual functionalized nanoparticles within the layer into respective depressions, such that the functionalized nanoparticles become positioned within the depressions in a predetermined configuration, and FIG. 4D depicts removing an excess amount of the layer of the nanoparticle suspension from the substrate surface; and

FIG. 5 is a black-and-white reproduction of a scanning electron microscope (SEM) image that was taken of a portion of a flow cell substrate surface including depressions defined therein, after a plurality of functionalized nanoparticles was introduced into the depressions.

### DETAILED DESCRIPTION

Methods of introducing functionalized nanoparticles to flow cell substrates with a high degree of precision and accuracy are disclosed herein. These methods may be used to introduce functionalized nanoparticles into individual concave features (e.g., depressions, wells, cavities, etc.) that have been defined in flow cell substrates. Examples of structures of a flow cell that can be formed and/or prepared using the methods disclosed herein will now be described.

### Definitions

It is to be understood that terms used herein will take on their ordinary meaning in the relevant art unless specified otherwise. Several terms used herein and their meanings are set forth below.

The singular forms “a”, “an”, and “the” include plural referents unless the context clearly dictates otherwise.

The terms comprising, including, containing and various forms of these terms are synonymous with each other and are meant to be equally broad.

The terms top, bottom, lower, upper, adjacent, on, etc. are used herein to describe the flow cell and/or the various components of the flow cell. It is to be understood that these directional terms are not meant to imply a specific orientation, but are used to designate relative orientation between components. The use of directional terms should not be interpreted to limit the examples disclosed herein to any specific orientation(s).

The terms first, second, etc. also are not meant to imply a specific orientation or order, but rather are used to distinguish one component from another.

An “acrylamide monomer” is a monomer with the structure

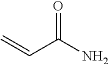

or a monomer including an acrylamide group. Examples of the monomer including an acrylamide group include azido acetamido pentyl acrylamide:

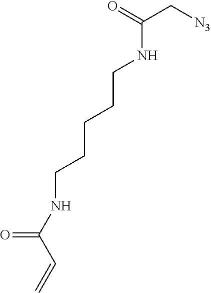 [SMILES: C=CC(=O)NCCCCCNC(=O)CN=[N+]=[N-]]

### and N-isopropylacrylamide:

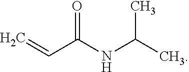

Other acrylamide monomers may be used.

An “aldehyde,” as used herein, is an organic compound containing a functional group with the structure-CHO, which includes a carbonyl center (i.e., a carbon double-bonded to oxygen) with the carbon atom also bonded to hydrogen and an R group, such as an alkyl or other side chain. The general structure of an aldehyde is:

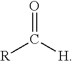

As used herein, “alkyl” refers to a straight or branched hydrocarbon chain that is fully saturated (i.e., contains no double or triple bonds). The alkyl group may have 1 to 20 carbon atoms. Example alkyl groups include methyl, ethyl, propyl, isopropyl, butyl, isobutyl, tertiary butyl, pentyl, hexyl, and the like. As an example, the designation “C1-4 alkyl” indicates that there are one to four carbon atoms in the alkyl chain, i.e., the alkyl chain is selected from the group consisting of methyl, ethyl, propyl, iso-propyl, n-butyl, isobutyl, sec-butyl, and t-butyl.

As used herein, “alkenyl” refers to a straight or branched hydrocarbon chain containing one or more double bonds. The alkenyl group may have 2 to 20 carbon atoms. Example alkenyl groups include ethenyl, propenyl, butenyl, pentenyl, hexenyl, and the like.

As used herein, “alkyne” or “alkynyl” refers to a straight or branched hydrocarbon chain containing one or more triple bonds. The alkynyl group may have 2 to 20 carbon atoms.

As used herein, “aryl” refers to an aromatic ring or ring system (i.e., two or more fused rings that share two adjacent carbon atoms) containing only carbon in the ring backbone. When the aryl is a ring system, every ring in the system is aromatic. The aryl group may have 6 to 18 carbon atoms. Examples of aryl groups include phenyl, naphthyl, azulenyl, and anthracenyl.

An “amino” functional group refers to an —NRₐR_{b} group, where Rₐ and R_{b} are each independently selected from hydrogen (e.g.,

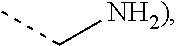

C1-6 alkyl, C2-6 alkenyl, C2-6 alkynyl, C3-7 carbocycle, C6-10 aryl, 5-10 membered heteroaryl, and 5-10 membered heterocyclyl, as defined herein.

As used herein, the terms “attached” refers to the state of two things being joined, fastened, adhered, connected or bound to each other, either indirectly or directly. As an example of an indirect chemical attachment, a primer may be attached to a nanoparticle core via an intervening hydrogel coating that is applied on the nanoparticle core (and thus the primer may be “indirectly attached” to the nanoparticle core). As an example of direct chemical attachment, a primer can be bonded to a hydrogel by a covalent or non-covalent bond (and thus the primer is “directly attached” to the hydrogel). A covalent bond is characterized by the sharing of pairs of electrons between atoms. A non-covalent bond is a physical bond that does not involve the sharing of pairs of electrons and can include, for example, hydrogen bonds, ionic bonds, van der Waals forces, hydrophilic interactions and hydrophobic interactions. Other examples of attachment include physical attachment, magnetic attachment, or electrostatic attachment.

An “azide” or “azido” functional group refers to —N₃.

As used herein, “carbocycle” means a non-aromatic cyclic ring or ring system containing only carbon atoms in the ring system backbone. When the carbocycle is a ring system, two or more rings may be joined together in a fused, bridged or spiro-connected fashion. Carbocycles may have any degree of saturation, provided that at least one ring in a ring system is not aromatic. Thus, carbocycles include cycloalkyls, cycloalkenyls, and cycloalkynyls. The carbocycle group may have 3 to 20 carbon atoms. Examples of carbocycle rings include cyclopropyl, cyclobutyl, cyclopentyl, cyclohexyl, cyclohexenyl, 2,3-dihydro-indene, bicyclo[2.2.2]octanyl, adamantyl, and spiro[4.4]nonanyl.

As used herein, the term “carboxylic acid” or “carboxyl” refers to —COOH.

As used herein, “cycloalkyl” refers to a completely saturated (no double or triple bonds) mono- or multi-cyclic hydrocarbon ring system. When composed of two or more rings, the rings may be joined together in a fused fashion. Cycloalkyl groups can contain 3 to 10 atoms in the ring(s). In some examples, cycloalkyl groups can contain 3 to 8 atoms in the ring(s). A cycloalkyl group may be unsubstituted or substituted. Example cycloalkyl groups include cyclopropyl, cyclobutyl, cyclopentyl, cyclohexyl, cycloheptyl, and cyclooctyl.

As used herein, “cycloalkenyl” or “cycloalkene” means a carbocycle ring or ring system having at least one double bond, wherein no ring in the ring system is aromatic. Examples include cyclohexenyl or cyclohexene and norbornenyl or norbornene. Also as used herein, “heterocycloalkenyl” or “heterocycloalkene” means a carbocycle ring or ring system with at least one heteroatom in ring backbone, having at least one double bond, wherein no ring in the ring system is aromatic.

As used herein, “cycloalkynyl” or “cycloalkyne” means a carbocycle ring or ring system having at least one triple bond, wherein no ring in the ring system is aromatic. An example is cyclooctyne. Another example is bicyclononyne. Also as used herein, “heterocycloalkynyl” or “heterocycloalkyne” means a carbocycle ring or ring system with at least one heteroatom in ring backbone, having at least one triple bond, wherein no ring in the ring system is aromatic.

The term “depositing,” as used herein, refers to any suitable application technique, which may be manual or automated, and, in some instances, results in modification of the surface properties. Generally, depositing may be performed using vapor deposition techniques, coating techniques, grafting techniques, or the like. Some specific examples include chemical vapor deposition (CVD), spray coating (e.g., ultrasonic spray coating), spin coating, dunk or dip coating, doctor blade coating, puddle dispensing, flow through coating, flow through deposition, aerosol printing, screen printing, microcontact printing, inkjet printing, or the like. Deposition may involve the use of a particular instrument, such as a precision fluid dispensing device (e.g., a slot-die coater).

The term “each,” when used in reference to a collection of items, is intended to identify an individual item in the collection, but does not necessarily refer to every item in the collection. Exceptions can occur if explicit disclosure or context clearly dictates otherwise.

The term “epoxy” (also referred to as a glycidyl or oxirane group) as used herein refers to

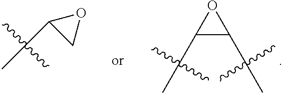

As used herein, the term “flow cell” is intended to mean a vessel having a flow channel where a reaction can be carried out, an inlet for delivering reagent(s) to the flow channel, and an outlet for removing reagent(s) from the flow channel. In some examples, the flow cell accommodates the detection of the reaction that occurs in the flow cell. For example, the flow cell can include one or more transparent surfaces allowing for the optical detection of arrays, optically labeled molecules, or the like.

As used herein, a “flow channel” or “channel” may be (i) an area defined between two bonded components or may be (ii) a concave area defined in a single substrate. In either case, the “flow channel” or “channel” can selectively receive a liquid sample, reagents, etc. In some examples, the flow channel may be defined between two substrates, and thus the flow channel may be in fluid communication with functionalized nanoparticles disposed within depressions on either of the two substrates. In other examples, the flow channel may be defined between one substrate and a lid, and thus the flow channel may be in fluid communication with the functionalized nanoparticles within depressions of the one substrate.

In some instances, the term “functionalized nanoparticle” or “nanoparticle” refers to i) a nanoparticle core, ii) a polymeric hydrogel attached to the nanoparticle core, and iii) a plurality of primers attached to side chains or arms of the polymeric hydrogel. In other instances, the terms refer to a polymeric hydrogel core with primers attached thereto. In each of these instances, when the functionalized nanoparticle has not yet been exposed to seeding and amplification, it may be referred to herein as being “non-pre-clustered.” Non-pre-clustered functionalized nanoparticles can be introduced into the depressions of the flow cell and then exposed to seeding and amplification (or can be used to provide a spatial genomic map a flow cell surface). In other instances, the functionalized nanoparticle may be further be referred to as being “pre-clustered,” meaning that each of the plurality of primers is seeded with a strand of template DNA (i.e., a library template) and exposed to amplification (i.e., to generate amplicons) prior to the introduction of the nanoparticles into the depressions of a flow cell.

As used herein, “heteroaryl” refers to an aromatic ring or ring system (i.e., two or more fused rings that share two adjacent atoms) that contain(s) one or more heteroatoms, that is, an element other than carbon, including but not limited to, nitrogen, oxygen, and sulfur, in the ring backbone. When the heteroaryl is a ring system, every ring in the system is aromatic. The heteroaryl group may have 5-18 ring members.

As used herein, “heterocycle” means a non-aromatic cyclic ring or ring system containing at least one heteroatom in the ring backbone. Heterocycles may be joined together in a fused, bridged, or spiro-connected fashion. Heterocycles may have any degree of saturation provided that at least one ring in the ring system is not aromatic. In the ring system, the heteroatom(s) may be present in either a non-aromatic or aromatic ring. The heterocycle group may have 3 to 20 ring members (i.e., the number of atoms making up the ring backbone, including carbon atoms and heteroatoms). In some examples, the heteroatom(s) are O, N, or S.

The term “hydrazine” or “hydrazinyl” as used herein refers to a —NHNH₂ group.

As used herein, the term “hydrazone” or “hydrazonyl” refers to a

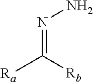

group in which Rₐ and R_{b} are each independently selected from hydrogen, C1-6 alkyl, C2-6 alkenyl, C2-6 alkynyl, C3-7 carbocycle, C6-10 aryl, 5-10 membered heteroaryl, and 5-10 membered heterocyclyl, as defined herein.

As used herein, “hydroxy” or “hydroxyl” refers to an —OH group.

The term “hydrogel” or “polymeric hydrogel” refers to a semi-rigid polymer that is permeable to liquids and gases. The hydrogel can swell when liquid (e.g., water) is taken up and that can contract when liquid is removed, e.g., by drying. While a hydrogel may absorb water, it is not water-soluble.

As used herein, the term “interstitial region” refers to an area, e.g., of a substrate that separates flow cell concave features, e.g., depressions, from one another. The separation provided by an interstitial region can be partial or full separation.

As used herein, a “nanoparticle core” or “core” refers to a central material included in a functionalized nanoparticle. In some instances, the core is coated with another material that is capable of attaching primers thereto. In other instances, the core is comprised of a material that is capable of attaching primers thereto.

“Nitrile oxide,” as used herein, means a “RₐC≡N⁺O⁻” group in which Rₐ is defined herein. Examples of preparing nitrile oxide include in situ generation from aldoximes by treatment with chloramide-T or through action of base on imidoyl chlorides [RC(Cl)═NOH] or from the reaction between hydroxylamine and an aldehyde.

“Nitrone,” as used herein, means a

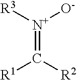

group in which R¹, R², and R³ may be any of the Rₐ and R_{b} groups defined herein, except that R³ is not hydrogen (H).

As used herein, a “nucleotide” includes a nitrogen containing heterocyclic base, a sugar, and one or more phosphate groups. Nucleotides are monomeric units of a nucleic acid sequence. In RNA, the sugar is a ribose, and in DNA, the sugar is a deoxyribose, i.e. a sugar lacking a hydroxyl group that is present at the 2′ position in ribose. The nitrogen containing heterocyclic base (i.e., nucleobase) can be a purine base or a pyrimidine base. Purine bases include adenine (A) and guanine (G), and modified derivatives or analogs thereof. Pyrimidine bases include cytosine (C), thymine (T), and uracil (U), and modified derivatives or analogs thereof. The C-1 atom of deoxyribose is bonded to N-1 of a pyrimidine or N-9 of a purine. A nucleic acid analog may have any of the phosphate backbone, the sugar, or the nucleobase altered. Examples of nucleic acid analogs include, for example, universal bases or phosphate-sugar backbone analogs, such as peptide nucleic acid (PNA). A “labeled nucleotide” is a nucleotide that has at least an optical label attached thereto. Examples of optical labels include any dye that is capable of emitting an optical signal in response to an excitation wavelength.

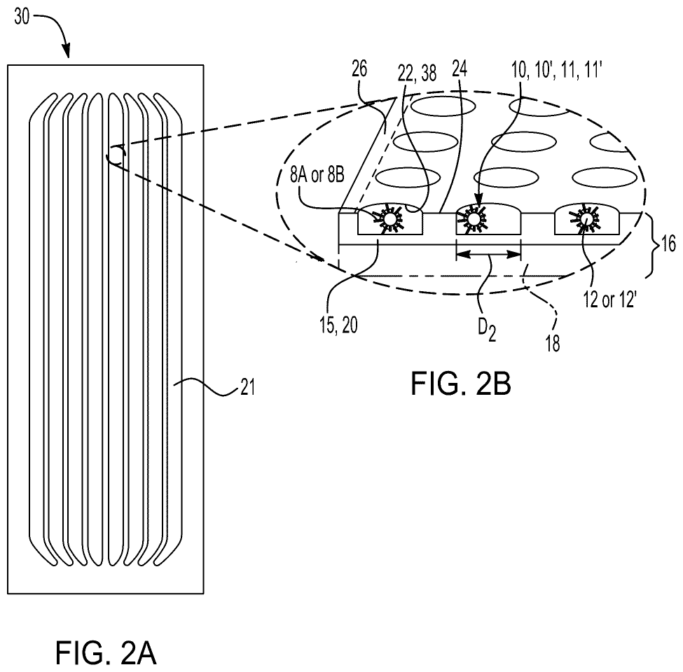

In some examples, the term “over” may mean that one component or material is positioned directly on another component or material. When one is directly on another, the two are in contact with each other. In FIG. 2B, for example, when a multi-layer substrate 16 (including a base support 18 and an additional layer 20) is used, the additional layer 20 of the multi-layer substrate 16 is directly over the base support 18 (i.e., with no intervening materials). In other examples, the term “over” may mean that one component or material is positioned indirectly on another component or material. By indirectly on, it is meant that a gap or an additional component or material may be positioned between the two components or materials. In FIG. 2B, for example, the functionalized nanoparticles 10, 10′, 11, 11′ are indirectly over the base support 18 of the multi-layer substrate 16, when the multi-layer substrate 16 is used. The layer 20 is positioned therebetween.

The term “patterned structure” refers to resin-based substrates or layers of substrates that have been patterned with any concave feature (e.g., using nanoimprint lithography).

As used herein, the term “primer” is defined as a single stranded nucleic acid sequence (e.g., single stranded DNA). Some primers, referred to herein as amplification primers, serve as a starting point for template amplification and cluster generation. Other primers, referred to herein as sequencing primers, serve as a starting point for DNA synthesis. The 5′ terminus of the primer may be modified to allow a coupling reaction with a functional group of the core or coating overlying the core. The primer length can be any number of bases long and can include a variety of non-natural nucleotides. In an example, the sequencing primer is a short strand, ranging from 10 to 60 bases, or from 20 to 40 bases.

The term “substrate” refers to a support material that can be patterned with depressions, or that can include an additional layer thereon that can be patterned with depressions (e.g., using nanoimprint lithography). For example, the term may refer to a single-layer substrate (such as the substrate 15 depicted in FIG. 2B), or a multi-layer substrate 16 including a base support 18 having an additional layer 20 thereon (as further depicted in FIG. 2B).

“Surface chemistry,” as defined herein, refers to primers that are present on functionalized nanoparticles.

The term “tantalum pentoxide” refers to the inorganic compound with the formula Ta₂O₅. This compound is transparent, having a transmittance ranging from about 0.25 (25%) to 1 (100%), to wavelengths ranging from about 0.35 μm (350 nm) to at least 1.8 μm (1800 nm). A “tantalum pentoxide substrate” may comprise, consist essentially of, or consist of Ta₂O₅. In examples where it is desirable for the tantalum pentoxide substrate to transmit electromagnetic energy having any of these wavelengths, the substrate may consist of Ta₂O₅ or may comprise or consist essentially of Ta₂O₅ and other components that will not interfere with the desired transmittance of the substrate.

A “thiol” functional group refers to —SH.

As used herein, the terms “tetrazine” and “tetrazinyl” refer to six-membered heteroaryl group comprising four nitrogen atoms. Tetrazine can be optionally substituted.

“Tetrazole,” as used herein, refer to five-membered heterocyclic group including four nitrogen atoms. Tetrazole can be optionally substituted.

The term “transparent” refers to a material, e.g., in the form of a substrate or layer, that is transparent to a particular wavelength or range of wavelengths. Transparency may be quantified using transmittance, i.e., the ratio of light energy falling on a body to that transmitted through the body. The transmittance of a transparent substrate or a transparent layer will depend upon the thickness of the substrate or layer and the wavelength of light. In the examples disclosed herein, the transmittance of the transparent substrate or the transparent layer may range from 0.25 (25%) to 1 (100%). The material of the substrate or layer may be a pure material, a material with some impurities, or a mixture of materials, as long as the resulting substrate or layer is capable of the desired transmittance. Additionally, depending upon the transmittance of the substrate or layer, the time for light exposure and/or the output power of the light source may be increased or decreased to deliver a suitable dose of light energy through the transparent substrate and/or layer to achieve the desired effect (e.g., introducing excitation wavelengths to a substrate surface).

### Flow Cells

The methods disclosed herein may be used to prepare a flow cell including a plurality of depressions defined therein. Each depression is a concave feature that is defined in a substrate. Each depression in the plurality is configured to be occupied by a functionalized nanoparticle, e.g., during a biological sequencing operation or genomic spatial decoding operation. Each functionalized nanoparticle includes a surface chemistry for seeding and clustering library templates. The structure of the functionalized nanoparticles will now be described.

### Functionalized Nanoparticles

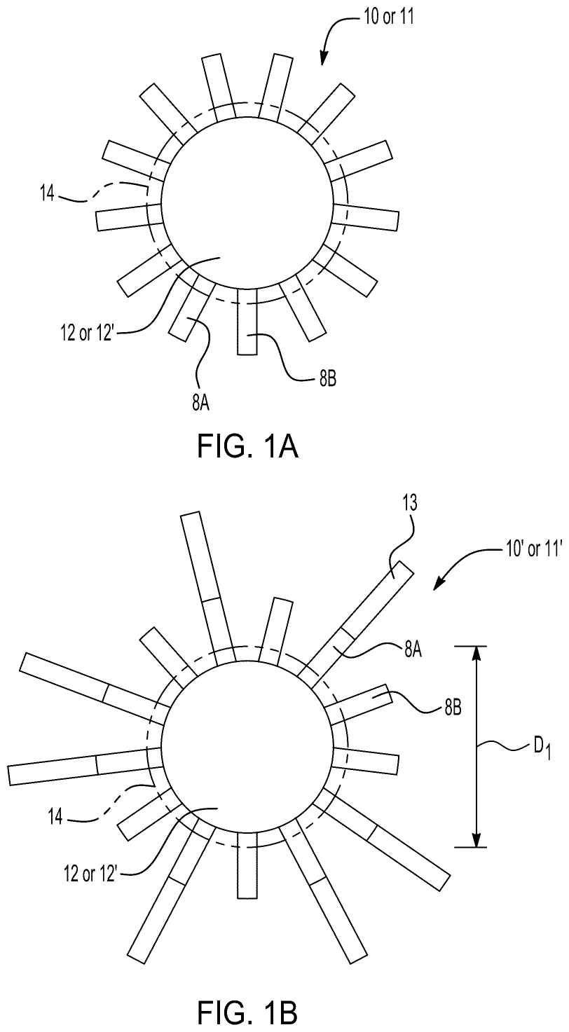

The functionalized nanoparticles that are configured to occupy the flow cells disclosed herein and that are used in the methods disclosed herein may be pre-clustered, or non-pre-clustered. Examples of the non-pre-clustered functionalized nanoparticles 10, 11 are shown in FIG. 1A, and examples of the pre-clustered functionalized nanoparticles 10′, 11′ are shown in FIG. 1B. The functionalized nanoparticles 10, 10′, 11, 11′ described herein generally include a polymeric hydrogel having oligonucleotide primers attached thereto.

Referring specifically to FIG. 1A, two examples of the non-pre-clustered functionalized nanoparticle 10, 11 are depicted. In one example, the functionalized nanoparticle 11 includes a hydrogel nanoparticle core 12′ and a plurality of primers 8A, 8B attached to the hydrogel nanoparticle core 12′. In another example, the functionalized nanoparticle 10 includes a nanoparticle core 12, a hydrogel coating 14 attached to the nanoparticle core 12, and a plurality of primers 8A, 8B attached to side chains or arms of the hydrogel coating 14. The non-pre-clustered functionalized nanoparticles 10, 11 may be introduced into the flow cell, and then on-board amplification may take place (as described in more detail herein).

Alternatively, the functionalized nanoparticles 10, 11 may be used in off-board amplification techniques, in which amplicons (also referred to herein as template nucleic acid strands 13) become attached to the primers 8A, 8B before the functionalized nanoparticle 10, 11 is introduced into the flow cell. Attachment of the template nucleic acid strands 13 to the primers 8A, 8B and subsequent amplification generates the pre-clustered functionalized nanoparticle 10′, 11′ shown in FIG. 1B. The pre-clustered functionalized nanoparticle 10′, 11′ may then be introduced into the flow cell for use in sequencing operations and/or to provide a spatial genomic map of the flow cell surface.

As mentioned, some examples of the functionalized nanoparticle 10 include the nanoparticle core 12, the hydrogel coating 14 attached to the nanoparticle core 12, and the plurality of primers 8A, 8B attached to side chains or arms of the hydrogel coating 14.

In these examples, the material making up the nanoparticle core 12 is generally rigid and is insoluble in an aqueous liquid. For example, the nanoparticle core 12 can be inert to chemistry used to attach the primer(s) 8A, 8B, used in sequencing reactions, etc. Examples of suitable core 12 materials include magnetic materials (e.g., magnetic FeOₓ, silica coated FeOₓ), plastics (e.g., polytetrafluoroethylene (PTFE), some polyacrylics, polypropylene, polyethylene, polybutylene, polyurethanes, polystyrene and other styrene copolymers), nylon (i.e., polyamide materials), polycaprolactone (PCL), nitrocellulose, silica (SiO₂), silica-based materials (e.g., functionalized SiO₂), carbon, or metals.

As mentioned, in some examples, the nanoparticle core 12 supports the hydrogel coating 14. In other examples, the hydrogel core 12′ is made up of the same type of hydrogel material used for the coating 14. In other words, the entire core 12′ is formed of the hydrogel material. In either example, the hydrogel material is a polymeric hydrogel. The polymeric hydrogel refers to a semi-rigid polymer that is permeable to liquids and gases. The polymeric hydrogel can swell when liquid (e.g., water) is taken up and that can contract when liquid is removed, e.g., by drying. A hydrogel material may absorb water while not being itself water-soluble.

Methods for forming the hydrogel core 12′ and for applying the hydrogel coating 14 on the nanoparticle core 12 are described in more detail below.

In some examples, the polymeric hydrogel material is poly(N-(5-azidoacetamidylpentyl) acrylamide-co-acrylamide (PAZAM, as described below) or another of the acrylamide copolymers disclosed herein, poly(ethylene glycol) (PEG)-acrylate, PEG-diacrylate, PEG-amine, PEG-carboxylate, PEG-dithiol, PEG-epoxide, PEG-isocyanate, PEG-maleimide, crosslinked poly(methyl methacrylate) (PMMA), polyvinylpyrrolidone (PVPON), polyvinyl alcohol (PVA), polyethylene oxide-polypropylene oxide block copolymers (PEO-PPO), poly(hydroxyethyl methacrylate) (PHEMA), poly(N-isopropylacrylamide) (PNIPAAm), poly(lactic acid)-poly(ethylene glycol) block copolymers, poly(ethylene glycol)-poly(lactic-co-glycolic acid) block copolymers, poly(acrylic-co-vinylsulfonic acid), poly(acrylamide-co-vinylsulfonic acid), poly(L-aspartic acid), poly(aspartamide), adipic dihydrazide modified or aldehyde modified poly(L-glutamic acid), bisacrylamide, or hydrogels based on one or more of polylysine, starch, agar, agarose, heparin, alginate, alginate sulfate, dextran sulfate, hyaluronan, pectin, carrageenan, gelatin, chitosan, cellulose, and collagen, or combinations or mixtures thereof.

As described, poly(N-(5-azidoacetamidylpentyl)) acrylamide-co-acrylamide, referred to herein as “PAZAM,” is one example of the hydrogel coating 14 or hydrogel core 12′. PAZAM and some other forms of the acrylamide copolymer are represented by the following structure (I):

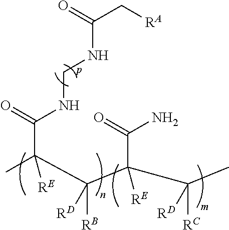

wherein:
R^{A} is selected from the group consisting of azido, optionally substituted amino, optionally substituted alkenyl, optionally substituted alkyne, halogen, optionally substituted hydrazone, optionally substituted hydrazine, carboxyl, hydroxy, optionally substituted tetrazole, optionally substituted tetrazine, nitrile oxide, nitrone, sulfate, and thiol;
R^{B} is H or optionally substituted alkyl;
R^{C}, R^{D}, and R^{E} are each independently selected from the group consisting of H and optionally substituted alkyl;
each of the —(CH₂)ₚ— can be optionally substituted;
p is an integer in the range of 1 to 50;
n is an integer in the range of 1 to 50,000; and
m is an integer in the range of 1 to 100,000.

The arrangement of the recurring “n” and “m” features in structure (I) are representative, and the monomeric subunits may be present in any order in the polymer structure (e.g., random, block, patterned, or a combination thereof).

The molecular weight of PAZAM and other forms of the acrylamide copolymer may range from about 5 kDa to about 1500 kDa or from about 10 kDa to about 1000 kDa, or may be, in a specific example, about 312 kDa.

In some examples, PAZAM and other forms of the acrylamide copolymer are linear polymers. In some other examples, PAZAM and other forms of the acrylamide copolymer are lightly cross-linked polymers.

In some examples, the gel material may be a variation of structure (I). In one example, the acrylamide unit may be replaced with N,N-dimethylacrylamide

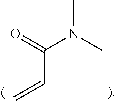

In another example, the acrylamide unit in structure (I) may be replaced with,

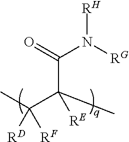

where R^{D}, R^{E}, and R^{F} are each H or a C1-C6 alkyl, and R^{G} and R^{H} are each a C1-C6 alkyl (instead of H as is the case with the acrylamide). In this example, q may be an integer in the range of 1 to 100,000. In another example, the N, N-dimethylacrylamide may be used in addition to the acrylamide unit. In this example, structure (I) may include

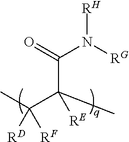

in addition to the recurring “n” and “m” features, where R^{D}, R^{E}, and R^{F} are each H or a C1-C6 alkyl, and R^{G} and R^{H} are each a C1-C6 alkyl. In this example, q may be an integer in the range of 1 to 100,000.

As another example, the recurring “n” feature in structure (I) may be replaced with a monomer including a heterocyclic azido group having structure (II):

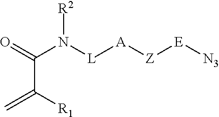

wherein R¹ is H or a C1-C6 alkyl; R² is H or a C1-C6 alkyl; L is a linker including a linear chain with 2 to 20 atoms selected from the group consisting of carbon, oxygen, and nitrogen and 10 optional substituents on the carbon and any nitrogen atoms in the chain; E is a linear chain including 1 to 4 atoms selected from the group consisting of carbon, oxygen and nitrogen, and optional substituents on the carbon and any nitrogen atoms in the chain; A is an N substituted amide with an H or a C1-C4 alkyl attached to the N; and Z is a nitrogen containing heterocycle. Examples of Z include 5 to 10 carbon-containing ring members present as a single cyclic structure or a fused structure. Some specific examples of Z include pyrrolidinyl, pyridinyl, or pyrimidinyl.

As still another example, the hydrogel coating 14 or hydrogel core 12′ may include a recurring unit of each of structure (III) and (IV):

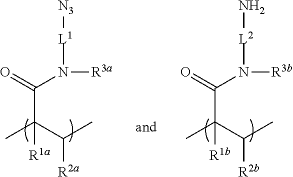

wherein each of R^{1a}, R^{2a}, R^{1b} and R^{2b} is independently selected from hydrogen, an optionally substituted alkyl or optionally substituted phenyl; each of R^{3a} and R^{3b} is independently selected from hydrogen, an optionally substituted alkyl, an optionally substituted phenyl, or an optionally substituted C7-C14 aralkyl; and each L¹ and L² is independently selected from an optionally substituted alkylene linker or an optionally substituted heteroalkylene linker.

In further examples, the polymeric hydrogel coating 14 or the hydrogel core 12′ is an alginate, acrylamide, or a PEG based material disclosed herein. In some examples, the polymeric hydrogel 14 or the hydrogel core 12′ is a PEG-based material with acrylate-dithiol, or epoxide-amine reaction chemistries. In some examples, the polymeric hydrogel coating 14 forms a polymer shell that includes PEG-maleimide/dithiol oil, PEG-epoxide/amine oil, PEG-epoxide/PEG-amine, or PEG-dithiol/PEG-acrylate.

Still further examples of suitable polymeric materials for the hydrogel coating 14 or hydrogel core 12′ include functionalized polysilanes, such as norbornene silane, azido silane, alkyne functionalized silane, amine functionalized silane, maleimide silane, or any other polysilane having functional groups that can attach the oligonucleotide primers 8A, 8B. Other examples of suitable hydrogel materials for the hydrogel coating 14 or the hydrogel core 12′ include those having a colloidal structure, such as agarose; or a polymer mesh structure, such as gelatin; or a cross-linked polymer structure, such as polyacrylamide polymers and copolymers, silane free acrylamide (SFA), or an azidolyzed version of SFA. Examples of suitable polyacrylamide polymers may be synthesized from acrylamide and an acrylic acid or an acrylic acid containing a vinyl group, or from monomers that form [2+2] photo-cycloaddition reactions. Still other examples of suitable polymeric hydrogel materials include mixed copolymers of acrylamides and acrylates. A variety of polymer architectures containing acrylic monomers (e.g., acrylamides, acrylates etc.) may be utilized in the examples disclosed herein, such as highly branched polymers, including dendrimers. For example, the monomers (e.g., acrylamide, etc.) may be incorporated, either randomly or in block, into the branches (arms) of a dendrimer.

An example of the dendritic polymeric hydrogel material includes a dendritic core with recurring units of formulas (II) and (III) in the arms extending from the dendritic core. The dendritic core may have anywhere from 3 arms to 30 arms.

The dendritic core may be any multi-functional component that enables a controlled polymerization mechanism, which leads to a defined arm length in the polymer structure and an at least substantially uniform arm length between polymer structures. In an example, the arms of the dendritic core are identical to each other.

The central molecule/compound of the dendritic core may be any multi-functional molecule, such as macrocycles (e.g., cyclodextrins, porphyrins, etc.), extended pi-systems (e.g., perylenes, fullerenes, etc.), metal-ligand complexes, polymeric cores, etc. Some specific examples of the central molecule/compound of the dendritic core include a phenyl group, benzoic acid, pentaerythritol, a phosphazene group, etc.

The dendritic core includes arms that extend from the central molecule/compound. Each arm may include a group that enables the monomers of formula (II) and (III) to be incorporated. In one example, a thiocarbonylthio group is included in each arm, and thus includes a reversible addition-fragmentation chain transfer agent (a RAFT agent). In another example, the dendritic core includes an atom transfer radical polymerization (ATRP) initiator in each arm. In still another example, the dendritic core includes a nitroxide (aminooxy) mediated polymerization (NMP) initiator in each arm.

Functional groups in one or more of the recurring units of the hydrogel material of the hydrogel coating 14 or the hydrogel core 12′ are capable of attaching the primers 8A, 8B. These functional groups (e.g., R² in formula (I), NH₂, N₃, etc.) may be located in the side chains of the linear or branched polymeric hydrogel material. As noted, one example of the branched polymeric hydrogel material is a dendrimer, and in an example, the primer-grafting functional groups are located in each of the arms of the dendrimer. These functional groups may be introduced as part of the monomer(s) used in copolymerization. To control the number of primer anchorage points, the monomer bearing the functional group may be increased or decreased. These functional groups may alternatively be introduced after copolymerization.

Other hydrogel materials may be used for the hydrogel coating 14, provided that these materials are functionalized to graft oligonucleotide primers 8A, 8B thereto and are capable of attaching to the nanoparticle core 12. It is also to be understood that other hydrogel materials may be used for the hydrogel core 12′, as long as they are functionalized to graft oligonucleotide primers 8A, 8B thereto.

Polymeric hydrogel coatings 14 or the hydrogel core 12′ may be prepared by cross-linking hydrophilic biopolymers or synthetic polymers or polymerizing suitable monomers and then cross-linking the resulting polymer. Thus, in some examples, the hydrogel coating 14 or the hydrogel core 12′ may include a crosslinker. As used herein, the term “crosslinker” refers to a molecule that can form a three-dimensional network when reacted with the appropriate base monomers. Examples of the previously listed hydrogel polymers may include one or more crosslinkers, such as N,N′-bis(acryloyl) cystamine, diamines, dopamine, cysteamine, and aminosilanes. In some examples, a crosslinker forms a disulfide bond in the hydrogel polymer, thereby linking hydrogel polymers.

In some examples, each of the plurality of functionalized nanoparticles 10, 10′ further includes silane at a surface of the nanoparticle core 12; and the polymeric hydrogel coating 14 attached to the silane. Silanization of the nanoparticle core 12 may be achieved by immersing the nanoparticle core 12 in a solution including a silane (e.g., trimethoxysilane or another suitable silane) and a suitable organic solvent.

In the functionalized nanoparticle 10, the thickness of the hydrogel coating 14 on the nanoparticle core 12 ranges from about 10 nm to about 200 nm. The hydrogel coating 14 can be in a dry state or can be in a swollen state, where it uptakes liquid. For example, the 10 nm thickness may represent the hydrogel coating 14 in the fully dry state, and the 200 nm thickness may represent the hydrogel coating 14 in the fully swollen state.

The weight average molecular weight of the hydrogel material used for the hydrogel coating 14 or the hydrogel core 12′ (linear or branched) ranges from about 5 kDa to about 2,000 kDa. In other examples, the weight average molecular weight ranges from about 100 kDa to about 400 kDa. Increasing the molecular weight will increase the thickness of the hydrogel coating 14. For the dendrimer version of the hydrogel coating 14, the branching number may also be used to achieve the desired thickness. Increasing the branching number will also increase the thickness of the hydrogel coating 14. In an example, the branching number ranges from 3 to 30.

The functionalized nanoparticles 10, 10′, 11, 11′ have a diameter D₁ (referred to herein as a “first diameter”) that is smaller than a diameter of each of a plurality of depressions that is included in the flow cell. In examples, the first diameter D₁ (e.g., of the functionalized nanoparticles 10, 10′, 11, or 11′) ranges from about 100 nm to about 1000 nm. In other examples, the first diameter D₁ ranges from about 225 nm to about 875 nm, or from about 250 nm to about 550 nm, or from about 275 nm to about 325 nm, or from about 290 nm to about 310 nm. These ranges may reflect the first diameter D₁ of the functionalized nanoparticle 10, 10′, 11, 11′ when the hydrogel coating 14 or hydrogel core 12′ is in a swollen state.

As mentioned, the functionalized nanoparticles 10, 10′, 11, 11′ also include the primers 8A, 8B, which may form a primer set. The polymeric hydrogel coating 14 over the core 12 or the hydrogel core 12′ provides a surface for attachment of the primers 8A, 8B.

The primer set attached to the polymeric hydrogel coating 14 or the hydrogel core 12′ includes two different primers 8A, 8B, e.g., that are used in sequential paired end sequencing. As examples, the primer set may include P5 and P7 primers, P15 and P7 primers, or any combination of the PA primers, the PB primers, the PC primers, and the PD primers set forth herein. As examples, the primer set may include any two PA, PB, PC, and PD primers, or any combination of one PA primer and one PB, PC, or PD primer, or any combination of one PB primer and one PC or PD primer, or a combination of one PC primer and one PD primer. Examples of P5 and P7 primers are used on the surface of commercial flow cells sold by Illumina Inc. for sequencing, for example, on HiSeq™, HiSeqX™, MiSeq™, MiSeqDX™, MiNISeq™, NextSeq™, NextSeqDX™, NovaSeq™, iSEQ™, Genome Analyzer™, and other instrument platforms. The P5 and P7 primers have a universal sequence for seeding and/or amplification purposes.

The P5 primer may be any of the following:

P5 #1: 5′→3′
(SEQ. ID. NO. 1)
AATGATACGGCGACCACCGAGAUCTACAC
P5 #2: 5′→3′
(SEQ. ID. NO. 2)
AATGATACGGCGACCACCGAGAnCTACAC

where “n” is inosine in SEQ. ID. NO. 2; or

P5 #3: 5′→3′
(SEQ. ID. NO. 3)
AATGATACGGCGACCACCGAGAnCTACAC

where “n” is alkene-thymidine (i.e., alkene-dT) in SEQ. ID. NO. 3.

The P7 primer may be any of the following:

P7 #1: 5′→3′
(SEQ. ID. NO. 4)
CAAGCAGAAGACGGCATACGAnAT
P7 #2: 5′→3′
(SEQ. ID. NO. 5)
CAAGCAGAAGACGGCATACnAGAT
P7 #3: 5′→3′
(SEQ. ID. NO. 6)
CAAGCAGAAGACGGCATACnAnAT

where “n” is 8-oxoguanine in each of the sequences.

The P15 primer is:

P15: 5′→3′
(SEQ. ID. NO. 7)
AATGATACGGCGACCACCGAGAnCTACAC

where “n” is allyl-T (a thymine nucleotide analog having an allyl functionality).

The other primers (PA-PD) mentioned above include:

PA 5′→3′
(SEQ. ID. NO. 8)
GCTGGCACGTCCGAACGCTTCGTTAATCCGTTGAG
PB 5′→3′
(SEQ. ID. NO. 9)
CGTCGTCTGCCATGGCGCTTCGGTGGATATGAACT
PC 5′→3′
(SEQ. ID. NO. 10)
ACGGCCGCTAATATCAACGCGTCGAATCCGCAACT
PD 5′→3′
(SEQ. ID. NO. 11)
GCCGCGTTACGTTAGCCGGACTATTCGATGCAGC

While not shown in the example sequences for PA-PD, it is to be understood that any of these primers may include a cleavage site, such as uracil, 8-oxoguanine, allyl-T, etc. at any point in the strand. It is to be further understood that the cleavage sites of the primers 8A, 8B in the primer set are orthogonal to each other (i.e., one cleavage site is not susceptible to a cleaving agent used for the other cleavage site), so that after amplification, forward or reverse strands can be cleaved, leaving the other of the reverse or forward strands for sequencing.

Each of the primers 8A, 8B disclosed herein may also include a polyT sequence at the 5′ end of the primer sequence. In some examples, the polyT region includes from 2 T bases to 20 T bases. As specific examples, the polyT region may include 3, 4, 5, 6, 7, or 10 T bases.

The 5′ end of each primer 8A, 8B may also include a linker. Any linker that includes a terminal alkyne group or another suitable terminal functional group that can attach to the surface functional groups of the hydrogel 14 or the hydrogel core 12′ may be used. In one example, 5′ end of the primers 8A, 8B are terminated with a hexynyl functionality.

The immobilization of the primers 8A, 8B may be by single point covalent attachment at the 5′ end of the primers 8A, 8B. The attachment will depend, in part, on the functional groups of the hydrogel coating 14 or the hydrogel core 12′. Examples of terminated primers that may be used include an alkyne terminated primer, a tetrazine terminated primer, an azido terminated primer, an amino terminated primer, an epoxy or glycidyl terminated primer, a thiophosphate terminated primer, a thiol terminated primer, an aldehyde terminated primer, a hydrazine terminated primer, a phosphoramidite terminated primer, and a triazolinedione terminated primer. As specific examples, a succinimidyl (NHS) ester terminated primer may be reacted with an amine of the hydrogel coating 14 or the hydrogel core 12′, an aldehyde terminated primer may be reacted with a hydrazine of the hydrogel coating 14 or the hydrogel core 12′, an alkyne terminated primer may be reacted with an azide of the hydrogel coating 14 or the hydrogel core 12′, an azide terminated primer may be reacted with an alkyne or DBCO (dibenzocyclooctyne) of the hydrogel coating 14 or the hydrogel core 12′, an amino terminated primer may be reacted with an activated carboxylate group or NHS ester of the hydrogel coating 14 or the hydrogel core 12′, a thiol terminated primer may be reacted with an alkylating reactant (e.g., iodoacetamine or maleimide) of the hydrogel coating 14 or the hydrogel core 12′, or a phosphoramidite terminated primer may be reacted with a thioether of the hydrogel coating 14 or the hydrogel core 12′. While several examples have been provided, it is to be understood that a functional group that can be attached to the primer 8A, 8B and that can attach to a functional group of the hydrogel coating 14 or the hydrogel core 12′ may be used.

In a specific example, each of the plurality of functionalized nanoparticles 10, 10′ further includes a polymeric hydrogel coating 14 attached to the nanoparticle core 12; each of the plurality of primers 8A, 8B is attached to a side chain or arm of the polymeric hydrogel coating 14; and each of the plurality of primers 8A, 8B is functionalized with an azide group or an alkyne group.

In examples, prior to being introduced to the flow cell substrate, the functionalized nanoparticles 10, 10′, 11, or 11′ are included in a suspension that further includes a suitable solvent (such as a polar aprotic solvent) and/or a buffer.

As mentioned, during the methods disclosed herein, the suspension including the functionalized nanoparticles 10, 10′, 11, or 11′ is introduced onto a flow cell substrate, such that the functionalized nanoparticles 10, 10′, 11, 11′ in the suspension become loaded into depressions of a flow cell. The structure of the flow cell will now be described.

### Flow Cell Structure

FIG. 2A depicts an example of the flow cell 30 disclosed herein from a top view, and an example of an architecture within a flow channel 21 of the flow cell 30 is shown in FIG. 2B. Examples of enclosed flow cells 30 may include one patterned structure bonded to a lid (lid not shown) or two patterned structures bonded together at a bonding region 26 (second patterned structure not shown). Another example of the flow cell 30 is an open-wafer flow cell that includes a single patterned structure that is open to the surrounding environment.

The example flow cell 30 shown in FIG. 2A includes eight flow channels 21. While eight flow channels 21 are shown, it is to be understood that any number of flow channels 21 may be included in the flow cell 30 (e.g., a single flow channel 21, four flow channels 21, etc.). When multiple flow channels 21 are included, each flow channel 21 may be isolated from another flow channel 21 so that fluid introduced into a flow channel 21 does not flow into (an) adjacent flow channel(s) 21. Further, as will be described herein, a slot-die coater can be used to introduce a suspension of functionalized nanoparticles 10, 10′, 11, 11′ to a single flow channel 21 during flow cell 30 preparation, such that the functionalized nanoparticles 10, 10′, 11, 11′ become loaded into individual depressions or other concave features within the single flow channel 21 (and do not flow into adjacent flow channels 21).

The flow channel(s) 21 in the enclosed form of the flow cells 30 is/are defined between the one patterned structure and the lid (when the lid is included) or between the one patterned structure and a second patterned structure. The patterned structure(s) and/or the lid are bonded together via a spacer layer that is positioned at bonding region(s) 26. Thus, each flow channel 21 in the enclosed form of the flow cells 30 is defined by the patterned structure, the spacer layer, and either the lid or the second patterned structure. Alternatively, when a single patterned structure is used (e.g., as an open-wafer substrate), the flow channel 21 may be defined by a concave area of the structure in which features (e.g., depressions) are formed. In this example, the depth of the concave area is greater than the depth of the depressions 22 defined within the concave area.

Each flow channel 21 is in fluid communication with an inlet and an outlet of the flow cell 30 (not shown). The inlet and outlet of each flow channel 21 may be positioned at opposed ends of the flow cell 30. The inlets and outlets of the respective flow channels 21 may alternatively be positioned anywhere along the length and width of the flow channel 21 that enables desirable fluid flow.

The inlet allows fluids to be introduced into the flow channel 21, and the outlet allows fluid to be extracted from the flow channel 21. Each of the inlets and outlets is fluidly connected to a fluidic control system (including, e.g., reservoirs, pumps, valves, waste containers, and the like) which controls fluid introduction and expulsion. Some examples of the fluids introduced into the flow channel 21 may introduce the suspension disclosed herein (e.g., the suspension including the plurality of functionalized nanoparticles 10, 10′, 11, 11′), reaction components (e.g., DNA sample, polymerases, sequencing primers, nucleotides, etc.), washing solutions, deblocking agents, etc.

The flow channel 21 may have any desirable shape. In an example, the flow channel 21 has a substantially rectangular configuration with curved ends (as shown in FIG. 2A). The length of the flow channel 21 depends, in part, upon the size of the single-layer substrate 15 or the multi-layer substrate 16 used to form the patterned structure. The width of the flow channel 21 depends, in part, upon the size of the substrate 15, 16 used to form the patterned structure, the desired number of flow channels 21, the desired space between adjacent flow channels 21, and the desired space at a perimeter of the patterned structure. The spaces between flow channels 21 and at the perimeter of the patterned structure may be sufficient for attachment to a lid (not shown) or another patterned structure (also not shown).

The depth of the flow channel 21 can be as small as a monolayer thick when microcontact, aerosol, or inkjet printing is used to deposit a separate material (e.g., the spacer layer) that defines at least a portion of the sidewalls of the flow channel 21. As other examples, the depth of the flow channel 21 can be about 1 μm, about 10 μm, about 50 μm, about 100 μm, or more. In an example, the depth may range from about 10 μm to about 100 μm. In another example, the depth may range from about 10 μm to about 30 μm. In still another example, the depth is about 5 μm or less. It is to be understood that the depth of the flow channel 21 may be greater than, less than or between the values specified above.

The spacer layer used to attach the patterned structure and the lid or used to attach the first patterned structure and the second patterned structure may be any material that will seal portions of the patterned structure and the lid or the second patterned structure. As examples, the spacer layer may be an adhesive, a radiation-absorbing material that aids in bonding, or the like. In some examples, the spacer layer is the radiation-absorbing material, e.g., KAPTON® black. As described, the spacer layer is positioned at (a) bonding region(s) 26 of the flow cell 30.

The patterned structure and the lid, or the patterned structure and the second patterned structure, may be bonded using any suitable technique, such as laser bonding, diffusion bonding, anodic bonding, eutectic bonding, plasma activation bonding, glass frit bonding, or other methods known in the art.

When used, the lid may be any material that is transparent to the excitation light that is directed toward the flow cell 30 (e.g., during a sequencing operation, a polymerization step, etc.). In optical detection systems, the lid may also be transparent to the emissions generated from reaction(s) taking place in the flow cell 30. As examples, the lid may include glass (e.g., borosilicate, fused silica, etc.) or a transparent polymer. A commercially available example of a suitable borosilicate glass is D 263@, available from Schott North America, Inc. Commercially available examples of suitable polymer materials, namely cyclo-olefin polymers, are the ZEONOR® products available from Zeon Chemicals L.P. In some instances, the lid is shaped to form the top of the flow cell 30, and in other instances, the lid is shaped to form both the top of the flow cell 30 as well as sidewalls the flow channel 21.

The patterned structure that is bonded to the lid or to the second patterned structure includes a substrate 15 or a substrate 16, as shown in FIG. 2B. The second patterned structure, when used, also includes a substrate 15 or 16. The substrate 15 is a single-layer substrate having depressions 22 or other concave features 38 defined therein, and the substrate 16 is a multi-layer substrate that includes a base support 18 and an additional layer 20 positioned over (i.e., directly on) the base support 18, where the layer 20 has depressions 22 or other concave features 38 defined therein. The layer 20 includes a separate single material which may be different than the material of the base support 18 of the substrate 16.

Examples of suitable materials for the single-layer substrate 15 include siloxanes (e.g., epoxy siloxane), glass, modified or functionalized glass, polystyrene and copolymers of styrene and other materials, polypropylene, polyethylene, polybutylene, polyurethanes, polytetrafluoroethylene (such as TEFLON® from Chemours), polyethylene terephthalate (PET), polycarbonate, cyclic olefins/cyclo-olefin polymers (COP) (such as ZEONOR® from Zeon), polyimides, nylon (polyamides), ceramics/ceramic oxides, silica (i.e., silicon dioxide (SiO₂)), fused silica, or silica-based materials, aluminum silicate, silicon and modified silicon (e.g., boron doped p+ silicon), silicon nitride (Si₃N₄), tantalum pentoxide (Ta₂O₅) or other tantalum oxide(s) (TaOₓ), hafnium oxide (HfO₂), carbon, metals, resins, or the like. Examples of suitable resins include inorganic oxides, such as tantalum pentoxide (e.g., Ta₂O₅) or other tantalum oxide(s) (TaOₓ), aluminum oxide (e.g., Al₂O₃), silicon oxide (e.g., SiO₂), hafnium oxide (e.g., HfO₂), indium tin oxide, titanium dioxide, etc., or polymeric resins, such as a polyhedral oligomeric silsesquioxane based resin (e.g., POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin, an amorphous fluoropolymer resin (e.g., CYTOP® from Bellex), and combinations thereof.

As mentioned, some examples of the flow cell 30 include the multi-layer substrate 16, which includes the base support 18 and at least one other layer 20 thereon. Any example of the single-layer substrate 15 may be used as the base support 18 of the multi-layer substrate 16. In these examples, the other layer 20 that is positioned on the base support 18 may be any material that can be etched or imprinted to form the depressions 22 or other concave features 38. Examples of the layer 20 include inorganic oxides, such as tantalum oxide (e.g., Ta₂O₅), aluminum oxide (e.g., Al₂O₃), silicon oxide (e.g., SiO₂), or hafnium oxide (e.g., HfO₂), or polymeric resins, such as a polyhedral oligomeric silsesquioxane based resin (e.g., POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin, an amorphous fluoropolymer resin (e.g., CYTOP® from Bellex), and combinations thereof.

Suitable deposition techniques for the layer 20 or for the substrate 15 include dip coating, dunk coating, spin coating, spray coating, puddle dispensing, ultrasonic spray coating, doctor blade coating, aerosol printing, screen printing, microcontact printing, etc. In some instances, in which the layer 20 or the substrate 15 includes a resin material, following deposition and patterning, the resin of the layer 20 or the substrate 15 may be cured or dried, e.g., via exposure to actinic radiation or heat.

In any of the examples set forth herein, the substrate 15 or 16 may be a circular sheet, a panel, a wafer, a die, etc. having a diameter ranging from about 2 mm to about 300 mm, e.g., from about 200 mm to about 300 mm, or may be a rectangular sheet, panel, wafer, die etc. having its largest dimension up to about 10 feet (about 3 meters). As one example, a die may have a width ranging from about 0.1 mm to about 10 mm. While example dimensions have been provided, it is to be understood that the substrate 15 or 16 may have any suitable dimensions.

As described, the substrate 15 or the layer 20 of the substrate 16 includes depressions 22 or other concave features 38 defined therein. In some examples (and as shown in FIG. 2B), each of the plurality of depressions 22 is separated from each other depression 22 in the plurality of depressions 22 by interstitial regions 24.

The depressions 22 or other concave features 38 may be formed in the layer 20 or in the substrate 15 using any suitable technique, such as nanoimprint lithography or photolithography. For example, a working stamp including a negative replica of the depressions 22 or other concave features 38 may be pressed into the layer 20 or into the material of the substrate 15 (e.g., when the layer 20 or the substrate 15 includes a resin) while the layer 20 or the substrate 15 is soft. Curing or drying of the resin may then be performed, e.g., via actinic radiation or heat, with the working stamp in place. Release of the working stamp forms the depressions 22 or other concave features 38 in the substrate 15 or in the layer 20.

Many different layouts of the depressions 22 and/or other concave features 38 may be envisaged, including regular, repeating, and non-regular patterns. In an example, the depressions 22 or concave features 38 are disposed in a hexagonal grid for close packing and improved density. Other layouts may include, for example, rectangular layouts, triangular layouts, and so forth. In some examples, the layout or pattern can be an x-y format in rows and columns. In some other examples, the layout or pattern can be a repeating arrangement of the depressions 22 or other concave features 38 and interstitial regions 24. In still other examples, the layout or pattern can be a random arrangement of the depressions 22 or other concave features 38 and the interstitial regions 24.

The layout or pattern may be characterized with respect to the density (number) of the depressions 22 or other concave features 38 in a defined area. For example, the depressions 22 or other concave features 38 may be present at a density of approximately 2 million per mm². The density may be tuned to different densities including, for example, a density of about 100 per mm², about 1,000 per mm², about 0.1 million per mm², about 1 million per mm², about 2 million per mm², about 5 million per mm², about 10 million per mm², about 50 million per mm², or more, or less. It is to be further understood that the density can be between one of the lower values and one of the upper values selected from the ranges above, or that other densities (outside of the given ranges) may be used. As examples, a high-density array may be characterized as having the depressions 22 or other concave features 38 separated by less than about 100 nm, a medium density array may be characterized as having the depressions 22 or other concave features 38 separated by about 400 nm to about 1 μm, and a low density array may be characterized as having the depressions 22 or other concave features 38 separated by greater than about 1 μm.

The layout or pattern of the depressions 22 or other concave features 38 may also or alternatively be characterized in terms of the average pitch, or the spacing from the center of one depression 22 or concave feature 38 to the center of an adjacent depression 22 or concave feature 38 (center-to-center spacing) or from the right edge of one depression 22 or concave feature 38 to the left edge of an adjacent depression 22 or concave feature 38. The pattern can be regular, such that the coefficient of variation around the average pitch is small, or the pattern can be non-regular in which case the coefficient of variation can be relatively large. In either case, the average pitch can be, for example, about 50 nm, about 0.15 μm, about 0.5 μm, about 1 μm, about 5 μm, about 10 μm, about 100 μm, or more, or less. The average pitch for a particular pattern of depressions 22 or concave features 38 can be between one of the lower values and one of the upper values selected from the ranges herein. In an example, the depressions 22 or concave features 38 have a pitch (center-to-center spacing) of about 1.5 μm. While example average pitch values have been provided, it is to be understood that other average pitch values may be used.

The size of each depression 22 or other concave feature 38 may be characterized by its volume, opening area, depth, and/or diameter or length and width. For example, the volume can range from about 1×10−3 μm³ to about 100 μm³, e.g., about 1×10⁻² μm³, about 0.1 μm³, about 1 μm³, about 10 μm³, or more, or less. For another example, the opening area can range from about 1×10−3 μm² to about 100 μm², e.g., about 1×10⁻² μm², about 0.1 μm², about 1 μm², at least about 10 μm², or more, or less. For still another example, the depth can range from about 0.1 μm to about 100 μm, e.g., about 0.5 μm, about 1 μm, about 10 μm, or more, or less. For another example, the depth can range from about 0.1 μm to about 100 μm, e.g., about 0.5 μm, about 1 μm, about 10 μm, or more, or less. For yet another example, the diameter or each of the length and width can range from about 0.1 μm to about 100 μm, e.g., about 0.5 μm, about 1 μm, about 10 μm, or more, or less.

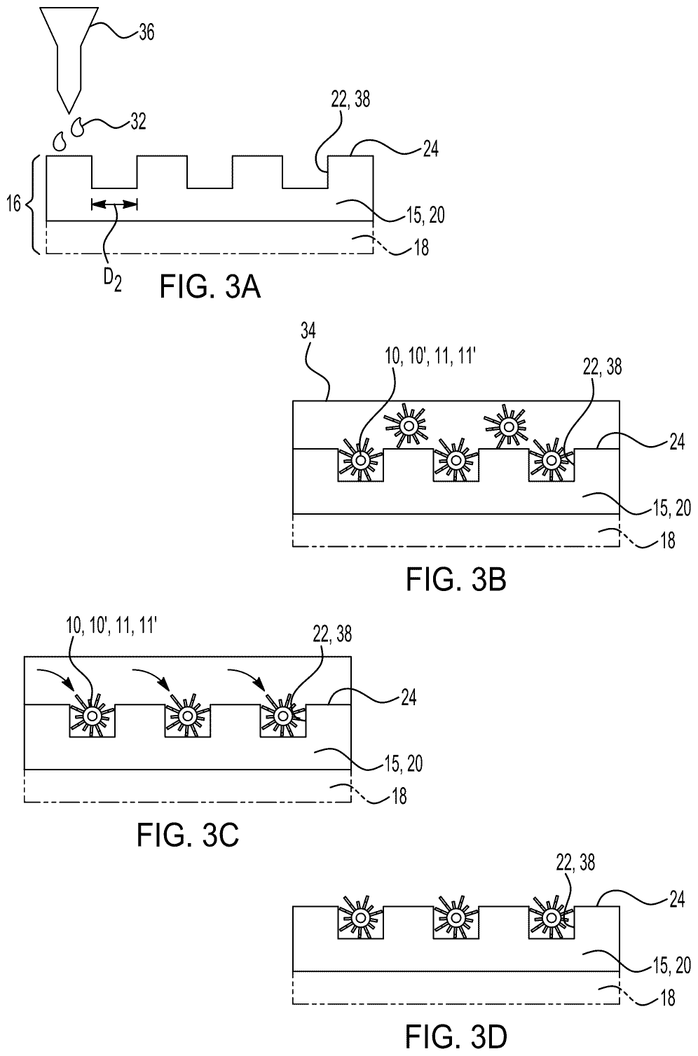

Each of the plurality of depressions 22 or other concave features 38 has a diameter D₂, as shown in FIG. 2B and in FIG. 3A through FIG. 3D (referred to herein as a “second” diameter D₂). The diameter D₂ may be representative of the diameter that extends throughout the depth of the depression 22 of may be representative of the diameter at the opening of, for example, a conical pit. It is to be understood that the first diameter D₁ (e.g., of each of the plurality of functionalized nanoparticles 10, 10′, 11, 11′ described herein) is less than or equal to the second diameter D₂. As such, the depressions 22 or concave features 38 can spatially accommodate at least a portion of the functionalized nanoparticles 10, 10′, 11, 11′.

In an example, the second diameter D₂ of the depressions 22 or other concave features 38 ranges from about 250 nm to about 1000 nm. In further examples, the second diameter D₂ ranges from about 325 nm to about 725 nm, or from about 350 nm to about 400 nm, or from about 300 nm to about 600 nm. In a specific example, the second diameter D₂ is about 360 nm.

As shown in FIG. 2B, at least one of the plurality of depressions 22 or other concave features 38 includes one functionalized nanoparticle 10, 10′, 11, 11′ therein. Depending on the method that is used to introduce the functionalized nanoparticles 10, 10′, 11, 11′ to the substrate 15 or to the layer 20, the functionalized nanoparticles 10, 10′, 11, 11′ may be positioned in the depressions 22 or other concave features 38 according to a predetermined configuration (e.g., disposed in a left portion of the depressions 22 or other concave features 38, or in a right portion of the depressions 22 or other concave features 38, etc.).

Methods of forming the functionalized nanoparticles 10, 10′, 11, 11′ will now be described.

### Method for Making the Non-Pre-Clustered Functionalized Nanoparticles 10, 11

To make the functionalized nanoparticle 10 shown in FIG. 1A, the hydrogel material is coated on the nanoparticle core 12 to form the coating 14. The hydrogel material may be coated on the nanoparticle core 12 using any suitable deposition technique. Examples of suitable deposition techniques include dip coating, dunk coating, spin coating, spray coating, puddle dispensing, ultrasonic spray coating, etc. In an example, the nanoparticle core 12 may be suspended in the polymeric hydrogel material and exposed to conditions (e.g., heat) that will initiate the attachment of the polymeric hydrogel to the nanoparticle core 12 for forming the coating 14. The type of attachment that is formed will depend upon the chemistry of the hydrogel material and the nanoparticle core 12.

As described, in some examples, the nanoparticle core 12 may include a silane that attaches the polymeric hydrogel material (e.g., of the hydrogel coating 14) to the nanoparticle core 12.

Prior to forming the functionalized nanoparticle 10, the hydrogel material may be prepared by polymerizing the monomer(s) that are to form the hydrogel coating 14. The polymerization process and process conditions will depend upon the monomer(s) included in the hydrogel material. In an example, the hydrogel material may be synthesized using reversible addition-fragmentation chain transfer (RAFT) polymerization. While RAFT polymerization may be used, it is to be understood that other polymerization processes may also be used. Other suitable polymerization processes include atom transfer radical polymerization (ATRP), nitroxide mediated radical (NMP) polymerization in combination with RAFT or ATRP, NMP with an additional cross-linking step, cobalt-mediated polymerization, group transfer polymerization (GTP), ring opening polymerization (ROP), ionic polymerization, or any other polymerization process that either directly or indirectly yields the desired linear or branched architecture.

Once the hydrogel material is formed and coated on the core 12 to form the hydrogel coating 14, the primers 8A, 8B may be grafted to the hydrogel coating 14. Grafting may involve dunk coating, which involves immersing the coated nanoparticle core (12 with 14 thereon) in a primer solution or mixture, which may include the primer(s) 8A, 8B, water, a buffer, and a catalyst. Other grafting techniques may involve spray coating, puddle dispensing, or another suitable method that will attach the primer(s) 8A, 8B to the hydrogel coating 14. With any of the grafting methods, the primers 8A, 8B react with reactive groups of the hydrogel coating 14.

In other examples, the primers 8A, 8B are grafted to the hydrogel material before the hydrogel coating 14 is formed on the core 12. In this example, the core 12 may be suspended in the pre-grafted polymeric hydrogel material and exposed to conditions (e.g., heat) that will initiate the attachment of the pre-grafted polymeric hydrogel material to the core 12. In these examples, additional grafting is not performed.

To make the functionalized nanoparticle 11 shown in FIG. 1A, the primers 8A, 8B are grafted to the hydrogel core 12′. The hydrogel core 12′ may be formed by emulsion polymerizing the monomer(s) in the presence of seed latexes and a surfactant, the latter of which promotes the coagulation of particles forming the nanoparticles. Particle growth depends on the nucleation speed, and can be controlled by adjusting the monomer ratio, the conversion rate, the polymerization temperature, etc. Any of the grafting techniques disclosed herein may be used to attach the primers 8A, 8B to the hydrogel core 12′.

These functionalized nanoparticles 10, 11 may be used in an on-flow cell amplification process for the generation of template nucleic acid strands 13.

### Method for Making the Pre-Clustered Functionalized Nanoparticles 10′, 11′

The functionalized nanoparticles 10, 11 may be used in an off-flow cell amplification process for the generation of template nucleic acid strands 13 (FIG. 1B) that are attached to the hydrogel coating 14 or hydrogel core 12′. This forms the pre-clustered nanoparticles 10′, 11′, which can then be used in sequencing, or to spatially decode a flow cell substrate surface, etc.

At the outset of template strand formation, library templates may be prepared from any nucleic acid sample (e.g., a DNA sample or an RNA sample). The DNA nucleic acid sample may be fragmented into single-stranded, similarly sized (e.g., <1000 bp) DNA fragments. The RNA nucleic acid sample may be used to synthesize complementary DNA (cDNA), and the cDNA may be fragmented into single-stranded, similarly sized (e.g., <1000 bp) cDNA fragments. During preparation, adapters may be added to the ends of any of the fragments. Through reduced cycle amplification, different motifs may be introduced in the adapters, such as sequencing primer binding sites, indices, and regions that are complementary to the primers 8A, 8B on the functionalized nanoparticles 10, 11. In some examples, the fragments from a single nucleic acid sample have the same adapters added thereto. The final library templates include the DNA or cDNA fragment and adapters at both ends. The DNA or cDNA fragment represents the portion of the final library template that is to be sequenced.

A plurality of library templates may be introduced to a suspension containing the functionalized nanoparticles 10, 11, where the suspension further includes the liquid carrier. Within the suspension, multiple library templates are individually hybridized, for example, to one of two types of primers 8A, 8B, which are immobilized to the functionalized nanoparticles 10, 11. In some examples, one library template is hybridized to one functionalized nanoparticle 10, 11. In other examples, multiple library templates are hybridized to one functionalized nanoparticle 10, 11.

Amplification of the template nucleic acid strand(s) on the functionalized nanoparticles 10, 11 may be initiated to form a cluster of the template strands 13 across the nanoparticle surface. This generates pre-clustered nanoparticles 10′, 11′. In one example, amplification involves cluster generation. In one example of cluster generation, the library templates are copied from the hybridized primers by 3′ extension using a high-fidelity DNA polymerase. The original library templates are denatured, leaving the copies immobilized all around the functionalized nanoparticles 10, 11. Isothermal bridge amplification or some other form of amplification may be used to amplify the immobilized copies. For example, the copied templates loop over to hybridize to an adjacent, complementary primer 8A or 8B, and a polymerase copies the copied templates to form double stranded bridges, which are denatured to form two single stranded strands. These two strands loop over and hybridize to adjacent, complementary primers 8A or 8B and are extended again to form two new double stranded loops. The process is repeated on each template copy by cycles of isothermal denaturation and amplification to create dense clonal clusters on the functionalized nanoparticles 10, 11. Each cluster of double stranded bridges is denatured. In an example, the reverse strand is removed by cleaving at the cleavage site (e.g., specific base cleavage), leaving forward template strands. In another example, the forward strand is removed by cleaving at the cleavage site, leaving reverse template strands. Clustering results in the formation of the pre-clustered nanoparticles 10′, 11′, which includes several template strands 13 immobilized on the functionalized nanoparticles 10, 11. This example of clustering is referred to as bridge amplification, and is one example of the amplification that may be performed. It is to be understood that other amplification techniques may be used, e.g., exclusion amplification.

When a single library template is hybridized and amplified on a single functionalized nanoparticle 10, 11, the resulting pre-clustered nanoparticle 10′, 11′ includes a monoclonal cluster of template strands 13.

The pre-clustered nanoparticles 10′, 11′ may be washed to remove unreacted library templates, etc. and suspended in a fresh carrier liquid.

Methods of introducing the functionalized nanoparticles 10, 10′, 11, 11′ to depressions 22 (or other concave features 38) defined in the substrate 15 or in the layer 20 of the substrate 16 will now be described.

### Flow Cell Preparation Methods

An example of a method of preparing the substrate 15 or 16 as part of a process of forming the flow cell 30 is depicted in FIG. 3A through FIG. 3D. The examples shown in these figures involve using a slot-die coater 36 at a continuous flow rate to introduce a nanoparticle suspension 32 to a substrate 15, 16 surface including depressions 22 separated by interstitial regions 24 (shown at FIG. 3A), thereby generating a layer 34 of the nanoparticle suspension 32 at a stable concentration across the substrate 15, 16 surface (shown at FIG. 3B), whereby at least some functionalized nanoparticles 10, 10′, 11, 11′ within the layer 34 respectively enter at least some of the depressions 22 (shown at FIG. 3C; and removing an excess amount of the layer 34 from the interstitial regions 24 (shown at FIG. 3D). This method may also be performed using a substrate 15, 16 that includes a concave feature 38 defined therein. The concave feature may be, as examples, an elongated trench, a conical pit, or any other concavity defined in the substrate 15, 16 surface. As such, another example of the method includes: using a slot-die coater 36, introducing a nanoparticle suspension 32 to a substrate 15, 16 surface, wherein the substrate 15, 16 surface includes a concave feature 38 defined therein; and during the introducing, maintaining a continuous flow rate, thereby generating a layer 34 of the nanoparticle solution 32 at a stable concentration across the concave feature 38.

The nanoparticle suspension 32 that is introduced to the substrate 15, 16 at FIG. 3A includes the functionalized nanoparticles 10, 10′, 11, 11′ and a liquid carrier. In some examples, the method involves formulating the nanoparticle suspension 32 prior to introducing the nanoparticle suspension 32 to the substrate 15, 16 surface.

The liquid carrier of the nanoparticle suspension 32 may be any suitable liquid that can be introduced to the substrate 15, 16 via the slot-die coater 36 and that can be used to suspend the functionalized nanoparticle(s) 10, 10′, 11, or 11′ with stability. In an example, the liquid carrier includes a buffer and a solvent. The solvent may be a polar aprotic solvent. In a specific example, the nanoparticle suspension consists of the functionalized nanoparticles 10, 10′, 11, 11′, the buffer, and the solvent. In another specific example, the liquid carrier includes a buffer (e.g., a phosphate buffer), a metal chloride salt, formamide, and a surfactant. Examples of suitable buffers for the liquid carrier of the nanoparticle suspension 32 include phosphate buffers, and suitable (polar aprotic) solvents include acetone, chloroform, and dichloromethane. Surfactants/dispersants, such as sodium dodecyl sulfate (e.g., sodium dodecyl sulfate (SDS) or cetyltrimethylammonium bromide (CTAB)) may also be included in the liquid carrier of the nanoparticle suspension 32.

The amount, or concentration, of functionalized nanoparticles 10, 10′, 11, 11′ suspended in the liquid carrier of the nanoparticle suspension 32 may depend, in part, upon the size (e.g., D₁) of each of the functionalized nanoparticles 10, 10′, 11, 11′ and the density of the depressions 22 or concave features 38 across the substrate 15, 16 surface. As an example, when the first diameter D₁ of each of the functionalized nanoparticles 10, 10′, 11, 11′ is greater than about 200 nm, a loading of 0.1 mg (of nanoparticles 10, 10′, 11, 11′) per mL of liquid carrier may be used. In this example, the concentration of functionalized nanoparticles 10, 10′, 11, 11′ in the liquid carrier ranges from about 50 million nanoparticles 10, 10′, 11, 11′ per mL of liquid carrier to about 500 million nanoparticles 10, 10′, 11, 11′ per mL of liquid carrier. This example concentration may be increased if the size of the nanoparticles 10, 10′, 11, 11′ remains the same and the density of the depressions 22 or concave features 38 is increased.

Returning now to FIG. 3A, this example method includes introducing the nanoparticle suspension 32 onto a surface of the substrate 15 or onto a surface of the layer 20 of the substrate 16 using the slot-die coater 36. The nanoparticle suspension 32 may be maintained in a separate reservoir (not shown) prior to and/or during the introducing of the nanoparticle suspension 32 to the substrate 15, 16 surface.

The slot-die coater 36 may be, for example, a slot-die coater 36 from FOM technologies, Torray Engineering Co., or MTI Corp.

During the introduction of the nanoparticle suspension 32, the nanoparticle suspension 32 becomes applied over an entirety of the substrate 15, 16 surface, such that the nanoparticle suspension 32 is applied within the depressions 22 (or other concave features 38) defined in the substrate 15 or in the layer 20, and such that the suspension 32 is also applied over the interstitial regions 24. The slot-die coater 36 may be used to introduce the nanoparticle suspension 32 at a continuous flow rate. The continuous flow rate may range from about 0.1 μL/s to about 10 μL/s. It is believed that the flow rates within this range contribute to the evaporative effect at the meniscus for effective loading of the functionalized nanoparticles 10, 10′, 11, 11′ in the depressions 22. Additionally, the evaporation at the meniscus front allows the particles 10, 10′, 11, 11′ to orient within the depressions 22 in the direction of loading. Thus, controlling the flow rate and direction of loading during the method enables one to control the positioning of at least some of the functionalized nanoparticles 10, 10′, 11, 11′ in the depressions 22.

Further, during the introducing of the nanoparticle suspension 32, the concentration of the functionalized nanoparticles 10, 10′, 11, 11′ in the suspension 32 may be kept substantially constant. By “substantially constant,” it is meant that the concentration of the functionalized nanoparticles 10, 10′, 11, 11′ in the suspension does not fluctuate by a significant margin (e.g., does not fluctuate by greater than about +/−5%) during the deposition. In an example, the method may involve continuously agitating the reservoir that includes the nanoparticle suspension 32 during the introducing of the nanoparticle suspension 32. This continuous agitation may aid in maintaining the stable concentration of the functionalized nanoparticles 10, 10′, 11, 11′ in the nanoparticle suspension 32 during the introduction of the suspension 32 to the substrate 15, 16 surface. By maintaining the concentration of the functionalized nanoparticles 10, 10′, 11, 11′ in the nanoparticle suspension 32 throughout its introduction across the substrate 15, 16, the number of particles that are dispensed can be controlled across the substrate 15, 16.

In some examples of the method, prior to introducing the suspension 32 to the substrate 15, 16, the method further comprises introducing template DNA to the suspension 32, wherein the template DNA becomes attached to the at least one of the plurality of primers 8A, 8B. The suspension containing the template DNA is exposed to conditions that initiate amplification as described herein, which forms the amplicons/DNA template strands 13. In these examples, the pre-clustered functionalized nanoparticle 10′ or 11′ is formed and is introduced to the substrate 15, 16 surface.

Returning now to FIG. 3B, after being introduced to the substrate 15, 16 surface, the nanoparticle suspension 32 forms the layer 34 over an entirety of the substrate 15, 16 surface. As shown in the figure, the layer 34 of the nanoparticle suspension 32 fills the depressions 22 or other concave features 38 and covers the interstitial regions 24 separating the depressions 22 or other concave features 38. The thickness of the layer 34 will depend, in part, upon a total volume of the nanoparticle suspension 32 that is applied during the process described in reference to FIG. 3A and upon the depth of the depressions 22 or other concave features 38.

As indicated by the arrows in FIG. 3C, the functionalized nanoparticles 10, 10′, 11, 11′ within the layer 34 respectively enter the depressions 22 or other concave features 38 that are defined in the substrate 15 or in the layer 20 of the substrate 16. The motion of the functionalized nanoparticles 10, 10′, 11, 11′ (i.e., from their suspended state in the layer 34 into the depressions 22 or other concave features 38) may be facilitated by evaporative forces, capillary forces, and/or convective forces. As such, examples of the method may involve allowing at least some of the layer 34 of the nanoparticle suspension 32 to evaporate to facilitate the loading of the functionalized nanoparticles 10, 10′, 11, 11′ into the depressions 22 or other concave features 38. In some examples of the method, heat and/or a continuous stream of air (or another suitable evaporation promoting gas) may be directly applied to the layer 34 of the nanoparticle suspension 32 to promote evaporation of the layer 34 (and to facilitate the loading of the functionalized nanoparticles 10, 10′, 11, 11′ in the depressions 22 or other concave features 38). As described, each functionalized nanoparticle 10, 10′, 11, 11′ has a (first) diameter D₁ that is less than or equal to the (second) diameter D₂ of each depression 22 or other concave feature 38. Thus, each depression 22 or concave feature 38 can spatially accommodate (at least) a portion of one functionalized nanoparticle 10, 10′, 11, 11′.

In an example, the first diameter D₁ ranges from about 250 nm to about 1000 nm. In an example, the second diameter D₂ ranges from about 100 nm to about 1000 nm.

Depending on the diameters D₁ and D₂ that are used, in some examples, multiple functionalized nanoparticles 10, 10′, 11, or 11′ are loaded into a single depression 22 or concave feature 38 (not shown in the figures). In one example, anywhere from one functionalized nanoparticle 10, 10′, 11, or 11′ to six functionalized nanoparticles 10, 10′, 11, or 11′ may be introduced into a single depression 22 or concave feature 38.

As shown in FIG. 3D, after the functionalized nanoparticles 10, 10′, 11, 11′ respectively enter the depressions 22 or other concave features 38, an excess amount of the layer 34 may be removed from the substrate 15, 16 (e.g., from the interstitial regions 24). In an example, removing the excess amount of the layer 34 from the interstitial regions 24 involves polishing the interstitial regions 24. In an example, removing the excess amount of the layer 34 from the interstitial regions 24 involves flowing a washing fluid over the interstitial regions. The washing fluid may be, for example, an aqueous liquid or an organic solvent.

It is to be understood that the functionalized nanoparticles 10, 10′, 11, 11′ remain in the depressions 22 or other concave features 38 during excess layer 34 removal due, at least in part, to Van der Waals interactions and/or the presence of a capture material located within the depressions 22 or other concave features 38. Examples of suitable capture materials include norbornene silane or capture primer(s) that are complementary to at least a portion of the primer(s) 8A or 8B on the functionalized nanoparticles 10, 10′, 11, 11′. The capture materials may be introduced to the depressions 22 or other concave features 38 during fabrication of the substrate 15, 16.

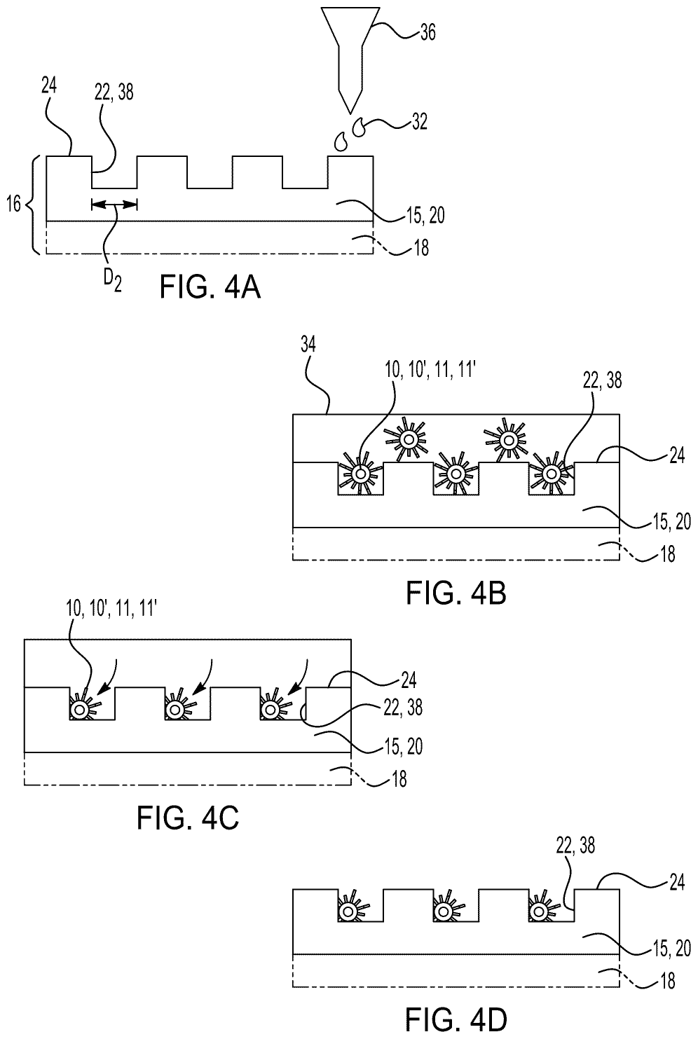

Turning now to FIG. 4A through FIG. 4D, the example methods depicted in these figures may be performed in a manner similar to those described in reference to FIG. 3A through FIG. 3D. However, in these examples, the method further involves aligning at least some of the nanoparticle suspension 32 within a predetermined portion of the depressions 22 (or within a predetermined portion of the concave feature 38) by controlling the slot-die coater 36 in a single direction along a length of the substrate 15, 16 surface.

As shown in FIG. 4A, the nanoparticle suspension 32 is introduced to the surface of the substrate 15 or the layer 20 of the substrate 16 using the slot-die coater 36.

During this process, the slot-die coater 36 is controlled in a single direction to apply the nanoparticle suspension 32 over the substrate 15 or layer 20 at desired areas, which forms the layer 34 of the nanoparticle suspension 32 shown at FIG. 4B.

Individual functionalized nanoparticles 10, 10′, 11, 11′ within the layer 34 then respectively enter the depressions 22 or concave features 38 in a predetermined configuration, as shown in FIG. 4C. The functionalized nanoparticles 10, 10′, 11, 11′, may, for example, align within the left side of the depressions 22 or concave features 38, or within the right side of the depressions 22 or concave features 38, etc. depending upon the single direction in which the slot-die coater 36 is operated. In some instances, a physical or chemical pattern is included in the depressions 22 or concave features 38 to aid in orienting the functionalized nanoparticles 10, 10′, 11, 11′ within the desired portion(s) of the depressions 22 or other concave features 38, or to aid in sequestering certain functionalized nanoparticles 10, 10′, 11, 11′ within certain desired depressions 22 or concave features 38. For example, the depressions 22 or concave features 38 may be of variable size to spatially accommodate different functionalized nanoparticles 10, 10′, 11, 11′, or the depressions 22 or concave features 38 may include a chemical capture agent (e.g., a complementary capture primer) to sequester functionalized nanoparticles 10, 10′, 11, 11′ of a certain type or in a particular orientation. For example, a chemical capture agent having reactive compatibility with the polymeric hydrogel coating 14, with the hydrogel core 12′, or with a functionality of the primers 8A, 8B can be included in certain depressions 22 or concave features 38.

As shown in FIG. 4D, an excess of the layer 34 is then removed from the substrate 15, 16, similar to the processes described in reference to FIG. 3D.

To further illustrate the present disclosure, an example is given herein. It is to be understood that this example is provided for illustrative purposes and is not to be construed as limiting the scope of the present disclosure.

### NON-LIMITING WORKING EXAMPLE

The method described in reference to FIG. 4A through FIG. 4D was performed to prepare an example flow cell substrate surface. A slot-die coater was used to introduce a nanoparticle suspension (including a solvent, a buffer, and a plurality of functionalized nanoparticles) onto a substrate surface patterned with depressions. The nanoparticle suspension formed a layer, and individual functionalized nanoparticles within the layer were allowed to respectively enter the depressions (e.g., via evaporative forces, convective forces, and/or capillary forces). An excess amount of the layer was removed using a washing solution.

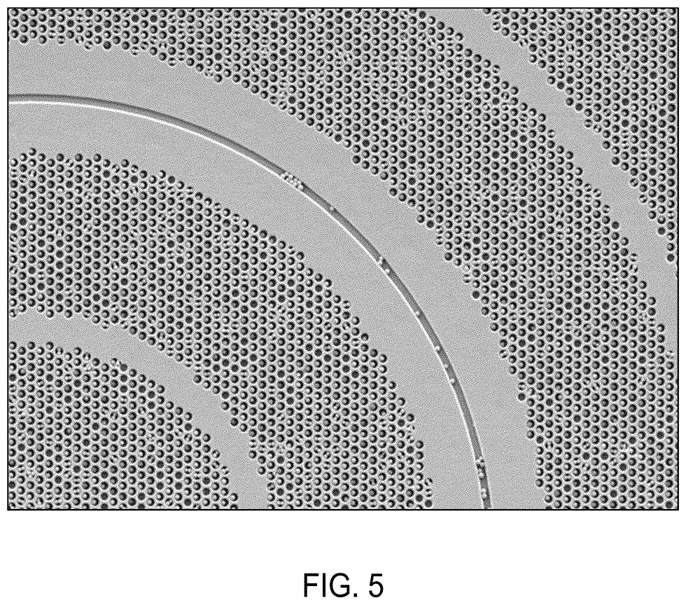

A scanning electron microscope (SEM) image was taken of a portion of the substrate surface after the removal of the excess amount of the layer and after evaporation was allowed to take place. A black-and-white reproduction of the image is shown in FIG. 5. As can be seen, one or more of the functionalized nanoparticles within the suspension entered individual depressions defined in the substrate surface, while the interstitial region(s) (e.g., the areas of the substrate between the depressions) remained free of functionalized nanoparticles.

This example demonstrates that the method(s) disclosed herein can be used to pattern flow cell substrates with functionalized nanoparticles with a high degree of precision and accuracy.

### Additional Notes

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it is to be understood that the disclosed examples may be modified. Therefore, the foregoing description is to be considered non-limiting.

What is claimed is:

1. A method of preparing a flow cell, comprising:
using a slot-die coater at a continuous flow rate, introducing a nanoparticle suspension to a substrate surface including depressions separated by interstitial regions, thereby generating a layer of the nanoparticle suspension at a stable concentration across the substrate surface, whereby at least some functionalized nanoparticles within the layer respectively enter at least some of the depressions; and
removing an excess amount of the layer from the interstitial regions.

2. The method as defined in claim 1, further comprising aligning at least some of the nanoparticle suspension within a predetermined portion of the at least some of the depressions by controlling the slot-die coater in a single direction along a length of the substrate surface.

3. The method as defined in claim 1, wherein the removing of the excess amount of the layer from the interstitial regions involves polishing the interstitial regions.

4. The method as defined in claim 1, wherein the removing of the excess amount of the layer from the interstitial regions involves flowing a washing fluid over the interstitial regions.

5. The method as defined in claim 1, wherein the nanoparticle suspension includes the functionalized nanoparticles, a buffer, and a solvent.

6. The method as defined in claim 1, wherein the continuous flow rate ranges from about 0.1 μL/s to about 10 μL/s.

7. The method as defined in claim 1, wherein the generating of the layer of the nanoparticle suspension at the stable concentration involves continuously agitating a reservoir that includes the nanoparticle suspension during the introducing of the nanoparticle suspension.

8. The method as defined in claim 1, wherein the functionalized nanoparticles include a polymeric hydrogel having oligonucleotide primers attached thereto.

9. A method of preparing a flow cell, comprising:
using a slot-die coater, introducing a nanoparticle suspension to a substrate surface, wherein the substrate surface includes a concave feature defined therein; and
during the introducing, maintaining a continuous flow rate, thereby generating a layer of the nanoparticle solution at a stable concentration across the concave feature.

10. The method as defined in claim 9, further comprising aligning at least some of the nanoparticle suspension within a predetermined portion of the concave feature by controlling the slot-die coater in a single direction along a length of the substrate surface.

11. The method as defined in claim 9, wherein the nanoparticle suspension includes functionalized nanoparticles, a buffer, and a solvent.

12. The method as defined in claim 11, wherein the functionalized nanoparticles include a polymeric hydrogel having oligonucleotide primers attached thereto.

13. The method as defined in claim 9, wherein the continuous flow rate ranges from about 0.1 μL/s to about 10 μL/s.

14. The method as defined in claim 9, wherein the generating of the layer of the nanoparticle suspension at the stable concentration involves continuously agitating a reservoir that includes the nanoparticle suspension during the introducing of the nanoparticle suspension.


SEQUENCE LISTING (11 sequences)

SEQ ID NO: 1 - DNA, 29 bp, Synthetic construct
  source 1..29: mol_type = other DNA
  modified_base 23: mod_base = OTHER; note = uracil
aatgatacggcgaccaccgagatctacac

SEQ ID NO: 2 - DNA, 29 bp, Synthetic construct
  modified_base 23: mod_base = OTHER; note = inosine
  source 1..29: mol_type = other DNA
aatgatacggcgaccaccgaganctacac

SEQ ID NO: 3 - DNA, 29 bp, Synthetic construct
  modified_base 23: mod_base = OTHER; note = alkene-thymidine
  source 1..29: mol_type = other DNA
aatgatacggcgaccaccgaganctacac

SEQ ID NO: 4 - DNA, 24 bp, Synthetic construct
  source 1..24: mol_type = other DNA
  modified_base 22: mod_base = OTHER; note = 8-oxoguanine
caagcagaagacggcatacganat

SEQ ID NO: 5 - DNA, 24 bp, Synthetic construct
  modified_base 20: mod_base = OTHER; note = 8-oxoguanine
  source 1..24: mol_type = other DNA
caagcagaagacggcatacnagat

SEQ ID NO: 6 - DNA, 24 bp, Synthetic construct
  modified_base 20: mod_base = OTHER; note = 8-oxoguanine
  modified_base 22: mod_base = OTHER; note = 8-oxoguanine
  source 1..24: mol_type = other DNA
caagcagaagacggcatacnanat

SEQ ID NO: 7 - DNA, 29 bp, Synthetic construct
  misc_difference 23: note = thymine nucleotide analog having an allyl functionality
  source 1..29: mol_type = other DNA
aatgatacggcgaccaccgaganctacac

SEQ ID NO: 8 - DNA, 35 bp, Synthetic construct
  source 1..35: mol_type = other DNA
gctggcacgtccgaacgcttcgttaatccgttgag

SEQ ID NO: 9 - DNA, 35 bp, Synthetic construct
  source 1..35: mol_type = other DNA
cgtcgtctgccatggcgcttcggtggatatgaact

SEQ ID NO: 10 - DNA, 35 bp, Synthetic construct
  source 1..35: mol_type = other DNA
acggccgctaatatcaacgcgtcgaatccgcaact

SEQ ID NO: 11 - DNA, 34 bp, Synthetic construct
  source 1..34: mol_type = other DNA
gccgcgttacgttagccggactattcgatgcagc